(19) United States
(12) Patent Application Publication
(10) Pub. No.: US 2017/0326035 A1
(43) Pub. Date: Nov. 16, 2017

(54) Nipple

(71) Applicants: Todd Strayer, Maumee, OH (US); Bobbie Strayer, Maumee, OH (US); Dean Alan Sparks, Saint Marys, GA (US)

(72) Inventors: Todd Strayer, Maumee, OH (US); Bobbie Strayer, Maumee, OH (US); Dean Alan Sparks, Saint Marys, GA (US)

(21) Appl. No.: 15/593,627

(22) Filed: May 12, 2017

Related U.S. Application Data
(60) Provisional application No. 62/335,872, filed on May 13, 2016.

(51) Int. Cl. A61J 11/00; A61J 7/00; A61J 17/00; A61J 9/00

(52) U.S. Cl. CPC A61J 11/0005; A61J 7/0053; A61J 17/006; A61J 17/001; A61J 9/00; A61J 11/001

(57) ABSTRACT

A fluid delivery device includes a nipple having a hollow body and a tip having a fluid exit opening. The body is symmetrical around an axis passing through the tip opening. The nipple includes a tab extending from the body radially outwardly from the axis. A syringe fits into the nipple to provide a source of medication or other fluids to be administered orally.

### REFERENCE TO RELATED APPLICATION

This application claims priority from U.S. Provisional Application Ser. No. 62/335,872, filed May 13, 2016, the disclosures of which are hereby incorporated by reference.

### BACKGROUND OF THE INVENTION

This invention relates in general to apparatus for delivering fluids and more particularly to apparatus for delivering fluid medication.

Infants and toddlers often resist the administering of medicine. To alleviate this problem, syringes are typically used to administer medicine to infants and toddlers. Syringes are usually rigid, and in the case of a struggling infant, could possibly be dangerous to the infant's eyes, mouth, and throat. Innovative apparatus including nipples, such as that disclosed in U.S. Pat. No. 8,985,357, the disclosure of which is incorporated herein by reference, has been used to facilitate the use of syringes to administer medications and other fluids.

In addition to using syringes to administering medications to infants and toddlers, syringes can be useful in administering medications and other fluids to adults, particularly senior adults and adults with swallowing or other ingestion issues.

Thus, it would be desirable to provide an improved apparatus for safely and effectively delivering medication and other fluids.

### SUMMARY OF THE INVENTION

The present invention is an improved nipple comprising a hollow body and a tip integrally formed with the body. The tip has an opening through which fluid may pass. The body has a central axis defining a fluid flow path. The body may be symmetrical around the axis. A tab or grip extends radially outwardly from the axis for ease of handling. The nipple is particularly useful when incorporated with a syringe, which may be in the form of an eyedropper, a tube and plunger, a vial, an elastomeric bulb, etc. As used herein, the term “syringe” includes various devices such as and eyedropper, a tube and plunger, a vial, an elastomeric bulb, etc. having a fluid reservoir and means for forcing fluid out of the fluid reservoir.

The nipple tip opening may include a diverter design to direct exiting fluid away from the central axis so that fluid entering a person's mouth is directed somewhat sideways toward the cheeks or otherwise away from the throat to prevent chocking, discomfort, etc. The nipple is particularly suitable for a single use in a hospital or medical office environment.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a nipple of the present invention.

FIG. 2 is a cross-sectional view of the nipple of FIG. 1 as used with a tube and plunger syringe.

FIG. 3 is a cross-sectional view of the top portion of the nipple of FIG. 1.

FIG. 4 is a cross-sectional view of an alternative top portion of the nipple of FIG. 1.

FIG. 5 is a cross-sectional view of an elastomeric bulb syringe.

FIG. 6 is a perspective view of a vial-type syringe.

### DESCRIPTION OF PREFERRED EMBODIMENTS

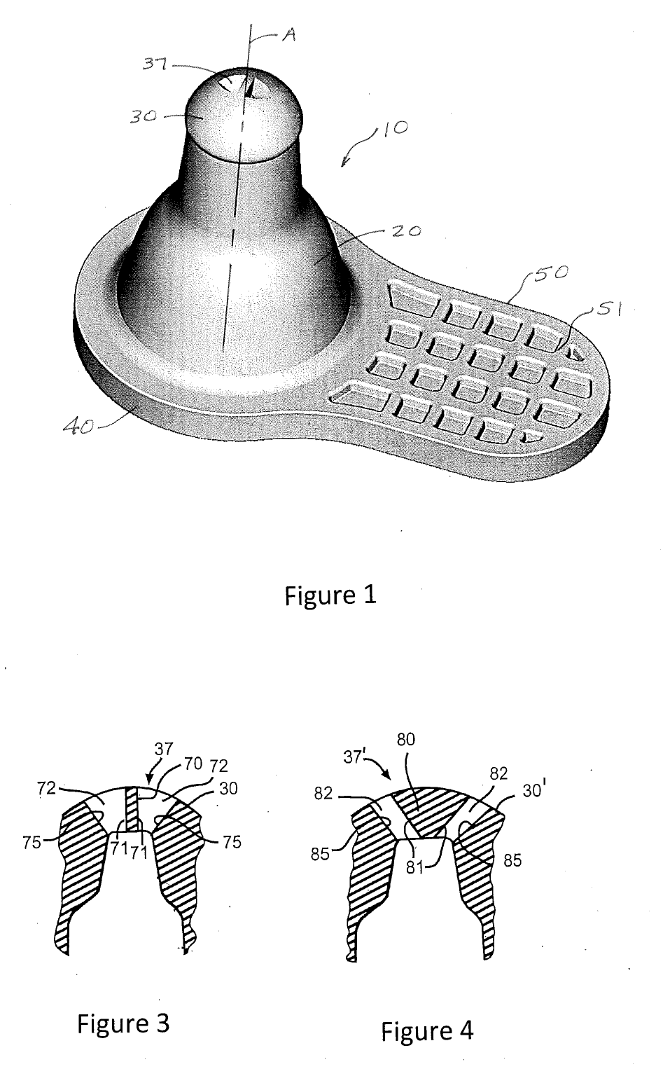

Referring to FIG. 1, a nipple 10 of the present invention has a flow path along an axis A. The nipple includes a body 20 symmetrical about axis A. The nipple has a tip 30 with an opening 37 which may include a diverter as shown and as will be discussed herein, or may have other configurations, including a traditional cross or circular opening.

The nipple has an integral annular base flange 40 surrounding and integrally formed with the body 20. A tab or finger grip 50 is integral with the base flange 40 and extends radially outwardly therefrom. Both the top surface 51 and bottom surface (not shown) of the tab 50 include similar waffle patterns with concave indentations to facilitate gripping. If the nipple has a diverter, the tab may be radially aligned with the diverter as shown and as will be discussed herein. The tab 50 provides a surface to touch and grab when assembling and disassembling the nipple onto a dispensing apparatus such as a syringe, and a handle for holding the apparatus.

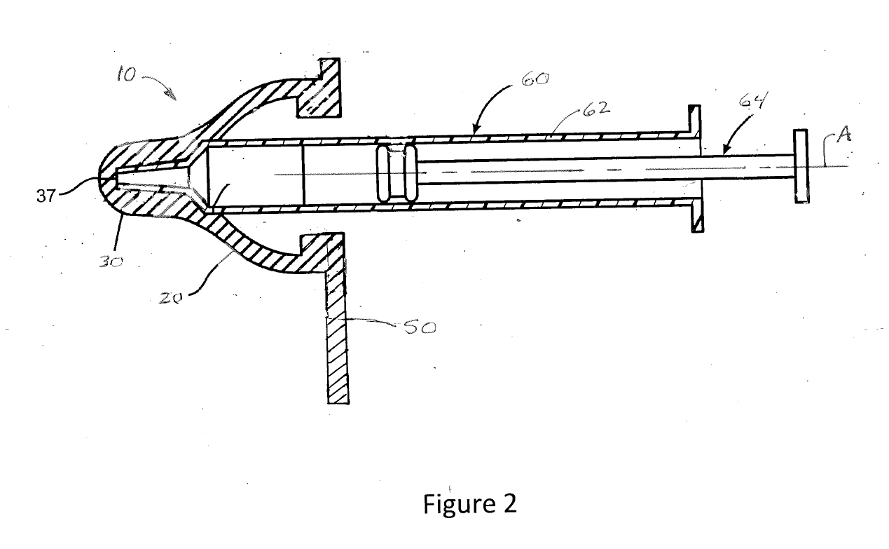

Referring to FIG. 2, a tube and plunger syringe 60 is shown inserted into the nipple 10. The syringe 60 extends along the same axis A as the nipple flow path. The syringe includes a fluid reservoir in the form of cylindrical tube 62 and a plunger 64, as is well known in the art. It can be seen that the tab 50 is particularly helpful in holding a fluid delivery device utilizing a syringe. Such devises are recommended for administering medication to children or infants. The nipple will assist a user in maintaining a positive grip on the syringe without touching or otherwise interfering with the person or touching the nipple body or tip. The nipple also allows the user a clear and unobstructed view of the medication being dosed, and how well the person is receiving it.

FIG. 3 more clearly shows the nipple tip opening 37. The opening 37 includes an integrally molded and centrally positioned fluid diverter 70 that divides the opening 37 into two passageways 72. The diverter 70 has flat parallel side walls 71. Opening 37 is also defined by angularly or transversely extending and generally conically shaped curved walls 75. The diverter 70 cooperates with the walls 75 to direct fluid flowing through the opening 37 in a directions B and C transverse to the nipple body axis A.

The purpose of the design of the spout or opening 37 is to prevent fluid from being forced directly down the throat of a user. The design of opening 37 allows fluid to be deflected away from a path directly into the throat of the user, preferably toward the cheeks. The orientation of the opening 37 is significant for this feature.

FIG. 4 shows an alternative downstream opening 37′. The opening 37′ includes an integrally molded diverter 80 that divides the opening 37′ into two passageways 82. The diverter 80 has side walls 81 which are angled relative to the nipple body axis A. Opening 37′ is also defined by angularly or transversely extending curved walls 85. The diverter 80 cooperates with the walls 85 to direct fluid flowing through the opening 37′ in a direction transverse to the nipple body axis A.

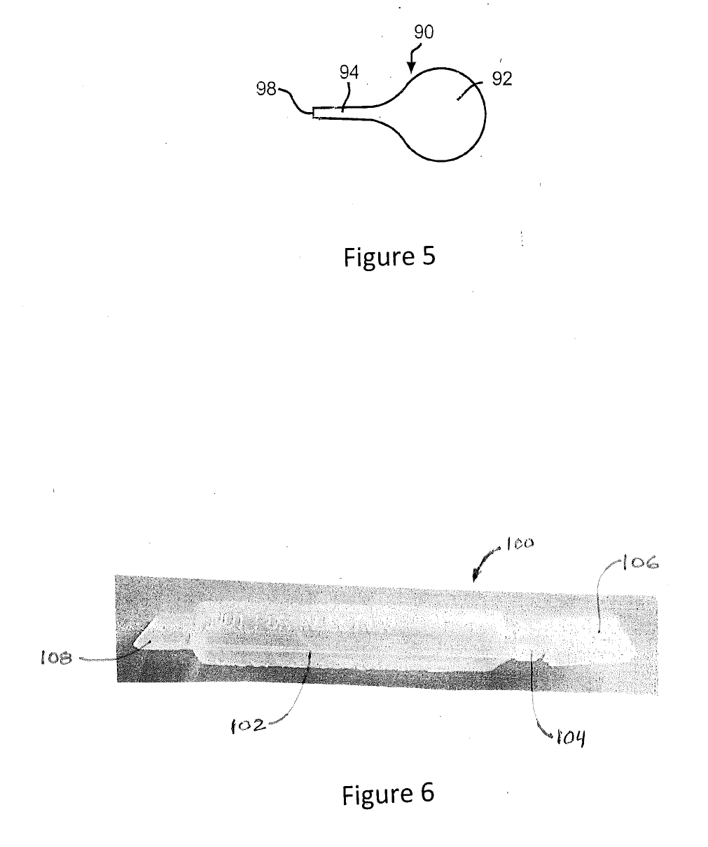

FIG. 5 shows an alternative syringe 90 in the form of a one piece elastomeric device having a fluid reservoir in the form of a bulb 92 and a tube spout 94 with an opening 98. FIG. 6 shows another alternative syringe in the form of a plastic vial 100 having an axially extending fluid reservoir 102, a fluid output spout 104 on the axis, and a holding tab 108 on the axis opposite the spout. A break away tab 106 seals the spout until use.

While the specific dimensions of nipple of the nipple of the present invention are not critical, the nipple disclosed in FIG. 1 preferably is approximately 1⅝ inches high, with the base flange 40 about 3/16 inch high, the body 20 about 1 3/16 inches high and the tip 30 about ¼ inch high. The diameter of the base flange 40 is about 1½ inches. The diameter of the lower portion of the body adjacent the base flange is about 1¼ inches, with the width of the base flange being about ⅛ inch. The diameter of the tip is about ½ inch.

The grip or tab 50 has a radially outwardly extending length of about 1¼ inches from the lower portion of the body 20 and a width of about 1 inch. The tab 50 and the base flange 40 have a thickness of about ⅛ inch.

The principles of this invention have been explained and illustrated in the preferred embodiments. However, it must be understood that this invention may be practiced otherwise than as specifically explained and illustrated without departing from its spirit or scope as defined in the claims.

What is claimed is:

1. A nipple comprising a hollow body and a tip integrally formed with the body, the tip having an opening, the body having a central fluid flow axis defining a fluid flow path, wherein the body is symmetrical around the axis and wherein the base comprises a tab extending radially outwardly from the axis.

2. The nipple defined in claim 1 further comprising an annular base flange surrounding and integrally formed with the body, wherein the tab is integrally formed with the base flange.

3. The nipple defined in claim 2 wherein the tip opening is asymmetrical.

4. The nipple defined in claim 3 wherein the tip opening comprises a transverse fluid diverter for diverting fluid in a direction transverse to the axis.

5. The nipple defined in claim 4 wherein the tab extends in the transverse direction.

6. The nipple defined in claim 5 wherein the fluid diverter divides the tip opening into two passageways.

7. The nipple defined in claim 6 wherein the passageways are skewed relative to the axis.

8. The nipple defined in claim 7 wherein the passageways are aligned with the transverse direction.

9. The nipple defined in claim 8 wherein the tab has a non-smooth grip surface.

10. The nipple defined in claim 9 wherein the tab had a patterned grip surface.

11. A fluid delivery device comprising:
a syringe having a fluid reservoir and a downstream opening, and
a nipple extending over the downstream opening, the nipple comprising a hollow body, a tip integrally formed with the body, the tip having an opening, wherein the body is symmetrical around an axis passing through the tip opening, and wherein the nipple comprises a tab extending radially outwardly from the axis.

12. The fluid delivery device defined in claim 11 wherein the nipple further comprises a generally annular base, wherein the tab is integrally formed with the base.

13. The fluid delivery device as defined in claim 11 wherein the syringe comprises an axially extending tube having a fluid reservoir and a plunger movable within the tube.

14. The fluid delivery device defined in claim 13 wherein the tube is generally cylindrical with a central axis extending the length of the tube, wherein the tube axis is co-axial with the nipple body axis.

15. A fluid delivery device as defined in claim 11 wherein the syringe comprises an elastomeric bulb with a spout, the spout defining the downstream opening.

16. A fluid delivery device as defined in claim 11 wherein the syringe comprises a vial.

17. A fluid delivery device comprising:
a syringe having a longitudinal axis, fluid reservoir and a downstream opening on the longitudinal axis, and
a nipple extending over the downstream opening, the nipple comprising a hollow body, a tip integrally formed with the body, the tip having an about the longitudinal axis, and a tab integrally formed with the body, the tab extending radially outwardly from the longitudinal axis.

18. The fluid deliver device defined in claim 17 wherein the tab extends radially outwardly at a generally right angle to the longitudinal axis.
